(19) United States
(12) Patent Application Publication
(10) Pub. No.: US 2026/0057638 A1
(43) Pub. Date: Feb. 26, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Takashi SHIBATA, Tokyo (JP); Shuhei YOSHIDA, Tokyo (JP); Makoto TERAO, Tokyo (JP); Toshinori HOSOI, Tokyo (JP); Takuya OGAWA, Tokyo (JP); Masahiro YAMAGUCHI, Tokyo (JP); Hiroyoshi MIYANO, Tokyo (JP); Yasunori BABAZAKI, Tokyo (JP); Toru TAKAHASHI, Tokyo (JP); Yuki TANAKA, Tokyo (JP); Ryuhei ANDO, Tokyo (JP)

(73) Assignee: NEC Corporation, Tokyo (JP)

(21) Appl. No.: 19/289,433

(22) Filed: Aug. 4, 2025

(30) Foreign Application Priority Data
Aug. 22, 2024 (JP) 2024-141087

(51) Int. Cl. G06V 10/40

(52) U.S. Cl. CPC G06V 10/40

(57) ABSTRACT

An information processing device according to the present disclosure includes: a memory configured to store instructions; and one or more processors configured to execute the instructions to: predict, for each of a plurality of cameras, a trajectory of an object included in at least one of a plurality of target images with reference to the plurality of target images captured by the plurality of cameras; transform each of the plurality of predicted trajectories into reference coordinates; calculate a degree of correlation with another trajectory for each of the plurality of trajectories transformed into the reference coordinates; integrate trajectories having the degree of correlation higher than a predetermined value; calculate parameters for spatially and temporally synchronizing images captured by the plurality of cameras with reference to the integrated trajectory; and transform each of the plurality of trajectories into the reference coordinate with reference to the parameter.

This application is based upon and claims the benefit of priority from Japanese Patent Application No. 2024-141087, filed on Aug. 22, 2024, the disclosure of which is incorporated herein in its entirety by reference.

### TECHNICAL FIELD

The present disclosure relates to an information processing device, an information processing method, and a recording medium.

### BACKGROUND ART

A technique related to prediction of a trajectory of a moving object is known. As an example, a technique for predicting a trajectory of an object using a radar is known, but the technique has a problem that it is difficult to identify objects having different appearances and noise due to the influence of irregular reflection of radio waves increases.

As another example, a technique using an image captured by a camera is known. For example, JP 2022-177391 A discloses a multiple-object tracking device that selects a camera to be used for updating a tracking result from among a plurality of cameras in consideration of a degree of shielding of an object, and updates the tracking result based on association between a detection result of the object in an image of the selected camera and a predicted position.

### SUMMARY

An exemplary object of the present disclosure is to provide a technique and the like for accurately predicting a trajectory of an object.

An information processing device according to an exemplary aspect of the present disclosure includes: a trajectory prediction means for predicting, for each of a plurality of cameras, a trajectory of an object included in at least one of a plurality of target images with reference to the plurality of target images captured by the plurality of cameras; a coordinate transformation means for transforming each of a plurality of trajectories predicted by the trajectory prediction means into reference coordinates; a trajectory correlation means for calculating a degree of correlation with another trajectory for each of the plurality of trajectories transformed into the reference coordinates; a trajectory integration means for integrating trajectories having the degree of correlation higher than a predetermined value; and a spatiotemporal synchronization means for calculating parameters for spatially and temporally synchronizing images captured by the plurality of cameras with reference to a trajectory integrated by the trajectory integration means, in which the coordinate transformation means transforms each of the plurality of trajectories into the reference coordinate with reference to the parameter.

An information processing method according to an exemplary aspect of the present disclosure causes at least one processor to execute: a process of predicting, for each of a plurality of cameras, a trajectory of an object included in at least one of a plurality of target images with reference to the plurality of target images captured by the plurality of cameras; a process of transforming each of a plurality of trajectories predicted by the trajectory prediction processing into reference coordinates; a process of calculating a degree of correlation with another trajectory for each of the plurality of trajectories transformed into the reference coordinates; a process of integrating trajectories having the degree of correlation higher than a predetermined value; and a process of calculating parameters for spatially and temporally synchronizing images captured by the plurality of cameras with reference to a trajectory integrated by the trajectory integration processing, in which in the coordinate transformation processing, the at least one processor transforms each of the plurality of trajectories into the reference coordinate with reference to the parameter.

An information processing program according to an exemplary aspect of the present disclosure is an information processing program for causing a computer to function as an information processing device including: a trajectory prediction means for predicting, for each of a plurality of cameras, a trajectory of an object included in at least one of a plurality of target images with reference to the plurality of target images captured by the plurality of cameras; a coordinate transformation means for transforming each of a plurality of trajectories predicted by the trajectory prediction means into reference coordinates; a trajectory correlation means for calculating a degree of correlation with another trajectory for each of the plurality of trajectories transformed into the reference coordinates; a trajectory integration means for integrating trajectories having the degree of correlation higher than a predetermined value; and a spatiotemporal synchronization means for calculating parameters for spatially and temporally synchronizing images captured by the plurality of cameras with reference to a trajectory integrated by the trajectory integration means, in which the coordinate transformation means transforms each of the plurality of trajectories into the reference coordinate with reference to the parameter.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an information processing device according to the present disclosure;

FIG. 2 is a flowchart illustrating a flow of an information processing method according to the present disclosure;

FIG. 3 is a diagram illustrating an example of an outline of processing in which the information processing device according to the present disclosure predicts a trajectory and calculates a parameter with reference to the predicted trajectory;

FIG. 4 is a block diagram illustrating a configuration of a second information processing device according to the present disclosure;

FIG. 5 is a flowchart illustrating a flow of a second information processing method according to the present disclosure;

FIG. 6 is a diagram illustrating an example of processing in which the information processing device according to the present disclosure generates an integrated trajectory; and

FIG. 7 is a block diagram illustrating a configuration of a computer that functions as an information processing device according to the present disclosure.

### EXAMPLE EMBODIMENT

Hereinafter, example embodiments of the present disclosure will be described. However, the present disclosure is not limited to the example embodiments described below, and various modifications can be made within the scope described in the claims. For example, example embodiments obtained by appropriately combining technical means adopted in the following example embodiments can also be included in the scope of the present disclosure. Example embodiments obtained by appropriately omitting some of the technical means adopted in the following example embodiments can also be included in the scope of the present disclosure. Effects mentioned in the following example embodiments are examples of effects expected in the example embodiments, and do not define the extension of the present disclosure. That is, example embodiments that do not achieve the advantages mentioned in the following example embodiments can also be included in the scope of the present disclosure.

### First Example Embodiment

A first example embodiment, which is one example of example embodiments of the present disclosure, will be described in detail with reference to the drawings. The present example embodiment is a basic form of each example embodiment described below. An application range of each technique adopted in the present example embodiment is not limited to the present example embodiment. That is, each technical means adopted in the present example embodiment can also be adopted in other example embodiments included in the present disclosure as long as no particular technical problem occurs. Each technical means illustrated in the drawings referred to for describing the present example embodiment can also be adopted in other example embodiments included in the present disclosure as long as no particular technical problem occurs.

### Configuration of Information Processing Device 1

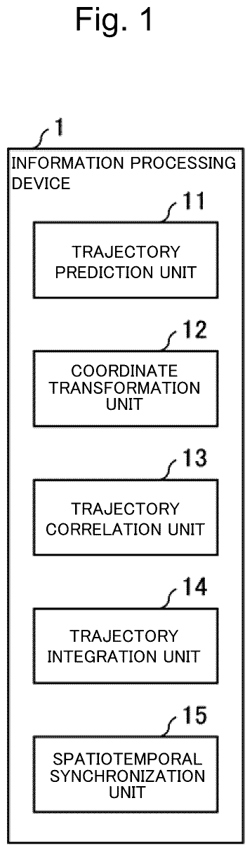

A configuration of an information processing device 1 will be described with reference to FIG. 1. FIG. 1 is a block diagram illustrating a configuration of the information processing device 1. As illustrated in FIG. 1, the information processing device 1 includes a trajectory 25 prediction unit 11, a coordinate transformation unit 12, a trajectory correlation unit 13, a trajectory integration unit 14, and a spatiotemporal synchronization unit 15. The trajectory prediction unit 11, the coordinate transformation unit 12, the trajectory correlation unit 13, the trajectory integration unit 14, and the spatiotemporal synchronization unit 15 implement a trajectory prediction means, a coordinate transformation means, a trajectory correlation means, a trajectory integration means, and a spatiotemporal synchronization means, in the present example embodiment.

### Trajectory Prediction Unit 11

For each of the plurality of cameras, the trajectory prediction unit 11 predicts a trajectory of an object included in at least one of the plurality of target images with reference to a plurality of target images captured by the cameras. The trajectory prediction unit 11 supplies information indicating the predicted trajectory to the coordinate transformation unit 12.

### Coordinate Transformation Unit 12

The coordinate transformation unit 12 transforms each of the plurality of trajectories predicted by the trajectory prediction unit 11 into reference coordinates. The coordinate transformation unit 12 supplies information indicating the transformed trajectory to the trajectory correlation unit 13.

The coordinate transformation unit 12 transforms each of the plurality of trajectories into reference coordinates with reference to parameters calculated by the spatiotemporal synchronization unit 15 described later.

### Trajectory Correlation Unit 13

The trajectory correlation unit 13 calculates a degree of correlation with other trajectories for each of the plurality of trajectories transformed into the reference coordinates. The trajectory correlation unit 13 supplies the calculated degree to the trajectory integration unit 14.

### Trajectory Integration Unit 14

The trajectory integration unit 14 integrates trajectories having a degree of correlation higher than a predetermined value. The trajectory integration unit 14 supplies information indicating the integrated trajectory to the spatiotemporal synchronization unit 15.

### Spatiotemporal Synchronization Unit 15

The spatiotemporal synchronization unit 15 refers to the trajectory integrated by the trajectory integration unit 14, and calculates parameters for spatially and temporally synchronizing the images captured by the plurality of cameras. The spatiotemporal synchronization unit 15 supplies the calculated parameter to the coordinate transformation unit 12.

### Effects of Information Processing Device 1

As described above, the information processing device 1 employs a configuration including, the trajectory prediction unit 11 that predicts, for each of a plurality of cameras, a trajectory of an object included in at least one of the plurality of target images with reference to the plurality of target images captured by the cameras, the coordinate transformation unit 12 that transforms each of the plurality of trajectories predicted by the trajectory prediction unit 11 into reference coordinates, the trajectory correlation unit 13 that calculates a degree of correlation with another trajectory for each of the plurality of trajectories transformed into reference coordinates, the trajectory integration unit 14 that integrates trajectories having a degree of correlation higher than a predetermined value, and the spatiotemporal synchronization unit 15 that refers to the trajectories integrated by the trajectory integration unit 14 and calculates parameters for spatially and temporally synchronizing the images captured by the plurality of cameras.

In the information processing device 1, the coordinate transformation unit 12 transforms each of the plurality of trajectories into reference coordinates with reference to the parameters calculated by the spatiotemporal synchronization unit 15.

Therefore, according to the information processing device 1, since the trajectories are integrated based on the target image captured by each of the plurality of cameras, even in an occlusion state in which an object is hidden by another object in an image captured by a certain camera, the trajectory is predicted based on an object included in an image captured by another camera. Therefore, according to the information processing device 1, the trajectory of the object can be predicted with high accuracy.

According to the information processing device 1, a parameter for spatially and temporally synchronizing images captured by a plurality of cameras is calculated with reference to the integrated trajectory, and a trajectory based on a target image captured by each of the plurality of cameras is transformed into a reference coordinate by using the parameter. Therefore, according to the information processing device 1, since the trajectory of the object is predicted after the trajectory based on the target image captured by each of the plurality of cameras is synchronized temporally and spatially, even in an occlusion state in which the object is hidden by another object in the image captured by a certain camera, the trajectory of the object can be predicted. That is, according to the information processing device 1, the trajectory of the object can be predicted with high accuracy.

### Flow of Information Processing Method S1

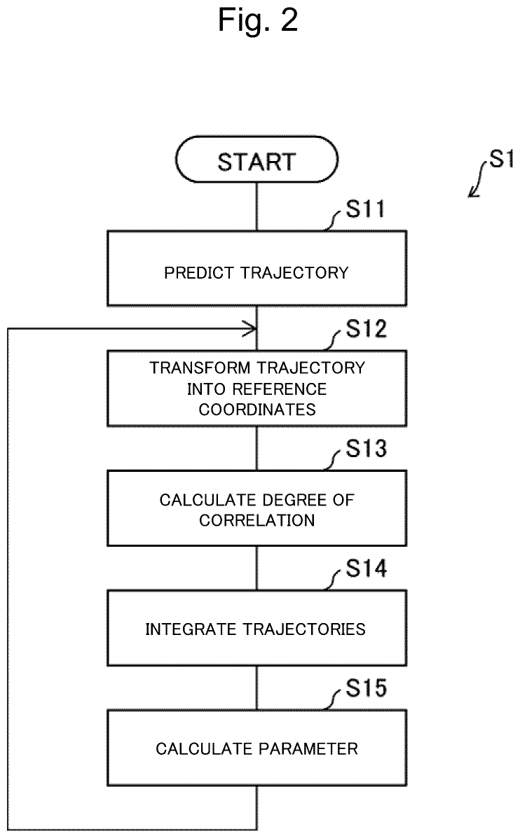

A flow of an information processing method S1 will be described with reference to FIG. 2. FIG. 2 is a flowchart illustrating the flow of the information processing method S1. As illustrated in FIG. 2, the information processing method S1 includes trajectory prediction processing S11, coordinate transformation processing S12, trajectory correlation processing S13, trajectory integration processing S14, and spatiotemporal synchronization processing S15.

### Trajectory Prediction Processing S11

In the trajectory prediction processing S11, the trajectory prediction unit 11 predicts, for each of the plurality of cameras, the trajectory of the object included in at least one of the plurality of target images with reference to the plurality of target images captured by the camera. The trajectory prediction unit 11 supplies information indicating the predicted trajectory to the coordinate transformation unit 12.

### Coordinate Transformation Processing S12

In the coordinate transformation processing S12, the coordinate transformation unit 12 transforms each of the plurality of trajectories predicted by the trajectory prediction unit 11 into reference coordinates. The coordinate transformation unit 12 supplies information indicating the transformed trajectory to the trajectory correlation unit 13.

### Trajectory Correlation Processing S13

In the trajectory correlation processing S13, the trajectory correlation unit 13 calculates the degree of correlation with other trajectories for each of the plurality of trajectories transformed into the reference coordinates. The trajectory correlation unit 13 supplies the calculated degree to the trajectory integration unit 14.

### Trajectory Integration Processing S14

In the trajectory integration processing S14, the trajectory integration unit 14 integrates trajectories having a degree of correlation higher than a predetermined value. The trajectory integration unit 14 supplies information indicating the integrated trajectory to the spatiotemporal synchronization unit 15.

### Spatiotemporal Synchronization Processing S15

In the spatiotemporal synchronization processing S15, the spatiotemporal synchronization unit 15 refers to the trajectory integrated by the trajectory integration unit 14, and calculates parameters for spatially and temporally synchronizing the images captured by the plurality of cameras. The spatiotemporal synchronization unit 15 supplies the calculated parameter to the coordinate transformation unit 12.

When the spatiotemporal synchronization processing S15 is executed, the coordinate transformation processing S12 is executed again. Here, in the coordinate transformation processing S12, the coordinate transformation unit 12 transforms each of the plurality of trajectories into reference coordinates with reference to the parameters calculated by the spatiotemporal synchronization unit 15.

### Effect of Information Processing Method S1

As described above, the information processing method S1 employs a configuration including the trajectory prediction processing S11 in which the trajectory prediction unit 11 predicts, for each of the plurality of cameras, a trajectory of an object included in at least one of the plurality of target images with reference to the plurality of target images captured by the camera, the coordinate transformation processing S12 in which the coordinate transformation unit 12 transforms each of the plurality of trajectories predicted by the trajectory prediction unit 11 into reference coordinates, the trajectory correlation processing S13 in which the trajectory correlation unit 13 calculates a degree of correlation with another trajectory for each of the plurality of trajectories transformed into reference coordinates, the trajectory integration processing S14 in which the trajectory integration unit 14 integrates trajectories having a degree of correlation higher than a predetermined value, and the spatiotemporal synchronization processing S15 in which the spatiotemporal synchronization unit 15 refers to the trajectories integrated by the trajectory integration unit 14 and calculates parameters for spatially and temporally synchronizing the images captured by the plurality of cameras.

In the information processing method S1, in the coordinate transformation processing S12, the coordinate transformation unit 12 transforms each of the plurality of trajectories into reference coordinates with reference to the parameters calculated by the spatiotemporal synchronization unit 15.

Therefore, according to the information processing method S1, effects similar to those of the information processing device 1 described above can be obtained.

### Second Example Embodiment

A second example embodiment, which is one example of example embodiments of the present disclosure, will be described in detail with reference to the drawings. Components having the same functions as the components described in the above-described example embodiment will be denoted by the same reference numerals, and the description thereof will be appropriately omitted. An application range of each technique adopted in the present example embodiment is not limited to the present example embodiment. That is, each technical means adopted in the present example embodiment can also be adopted in other example embodiments included in the present disclosure as long as no particular technical problem occurs. Each technique illustrated in each of the drawings referred to for describing the present example embodiment can be employed in the other example embodiments included in the present disclosure within a range in which no particular technical problem occurs.

### Outline of Information Processing Device 2

An information processing device 2 is a device that predicts a trajectory of an object included in at least one of a plurality of target images captured by each of a plurality of cameras. The information processing device 2 refers to the predicted trajectory, and calculates a parameter for spatially and temporally synchronizing images captured by each of the plurality of cameras.

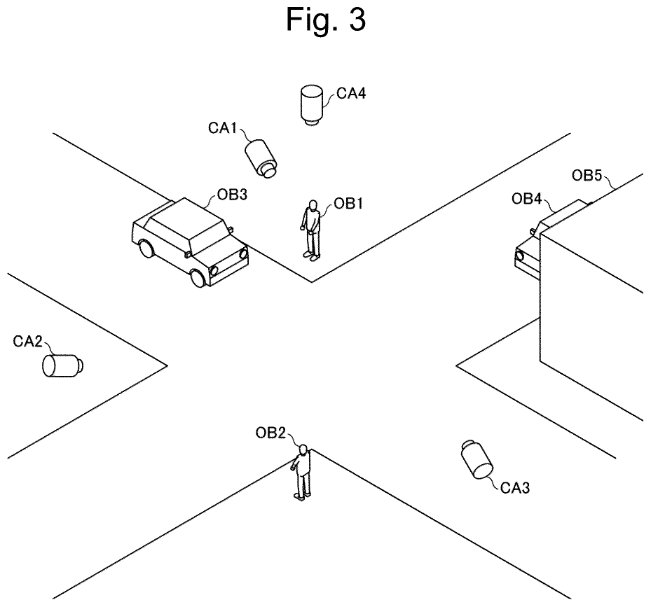

An example of an outline of processing in which the information processing device 2 predicts a trajectory and calculates a parameter with reference to the predicted trajectory will be described with reference to FIG. 3. FIG. 3 is a diagram illustrating an example of an outline of processing in which the information processing device 2 predicts a trajectory and calculates a parameter with reference to the predicted trajectory.

FIG. 3 illustrates a state in which a plurality of cameras CA1 to CA4 capture an image of an intersection. The information processing device 2 acquires target images captured by the plurality of cameras CA1 to CA4, and predicts a trajectory of an object included in at least one of the target images. For example, the information processing device 2 predicts the trajectory of the person OB1 included in the target image captured by each of the plurality of cameras CA1 to CA4.

In FIG. 3, in the image captured by the camera CA3, the position of a car OB4 is in an occlusion state hidden behind a building OB5. Even in such a case, the information processing device 2 acquires the target image captured by each of the plurality of cameras CA1 to CA4 and predicts the trajectory of the car OB4.

The information processing device 2 refers to the predicted trajectory and calculates a parameter for spatially and temporally synchronizing images captured by the cameras CA1 to CA4. As an example, the information processing device 2 calculates a parameter to be referred to for spatially and temporally synchronizing images captured by the cameras CA1 to CA4.

For example, the information processing device 2 calculates a parameter for referring to a plurality of target images captured at the same time among a plurality of target images captured by the cameras CA1 to CA4 as a parameter for temporal synchronization. As an example, the information processing device 2 calculates a parameter to be referred to for specifying a plurality of target images captured at the same time among a plurality of target images captured by each of the cameras CA1 to CA4.

In a case where the person OB1 is included in the plurality of target images captured at the same time, the information processing device 2 calculates a parameter for referring to the position of the person OB1 included in each of the plurality of target images as the same position as a parameter for spatial synchronization.

Examples of calculated parameters include, but are not limited to, rotation, translation, focal length, camera center coordinates, and camera lens distortion.

### Configuration of Information Processing Device 2

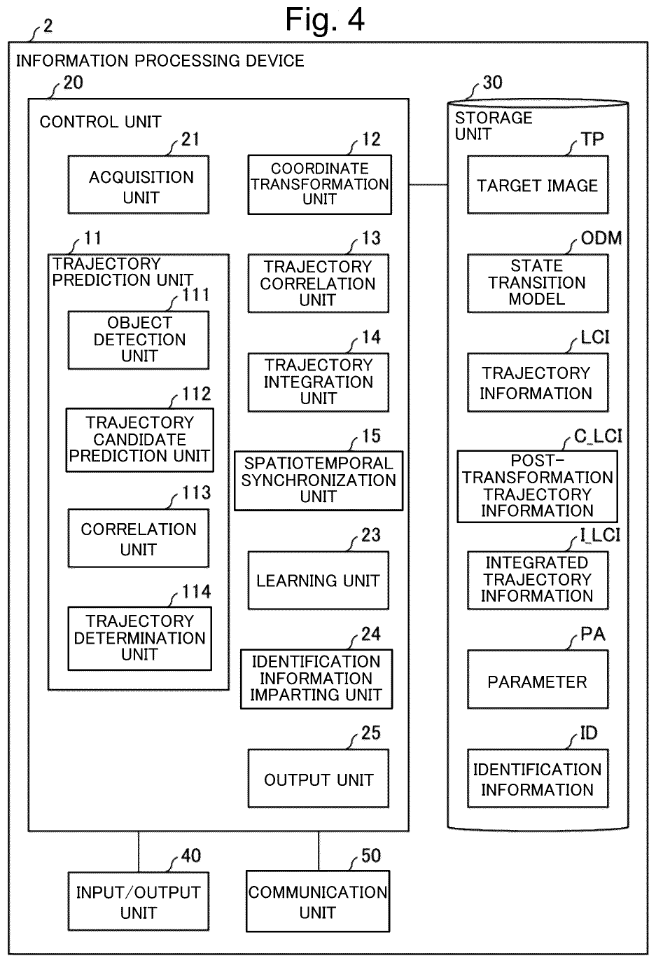

The configuration of the information processing device 2 will be described with reference to FIG. 4. FIG. 4 is a block diagram illustrating the configuration of the information processing device 2. As illustrated in FIG. 4, the information processing device 2 includes a control unit 20, a storage unit 30, an input/output unit 40, and a communication unit 50.

### Storage Unit 30

The storage unit 30 stores data to be referred to by the control unit 20. Examples of the storage unit 30 include, but are not limited to, a flash memory, a hard disk drive (HDD), a solid state drive (SSD), or a combination thereof.

Examples of the data stored in the storage unit 30 include, but are not limited to, a target image TP, a state transition model ODM, trajectory information LCI, post-transformation trajectory information C_LCI, integrated trajectory information I_CLI, a parameter PA, and identification information ID. The target image TP and the parameter PA are as described above. The trajectory information LCI, the post-transformation trajectory information C_LCI, the integrated trajectory information I_CLI, and the identification information ID will be described later.

The state transition model ODM is a model machine-learned so as to predict a state of an object included in an image using the image as an input. As an example, the state transition model ODM is a model learned to predict a trajectory of an object included in a plurality of images as an input.

More specifically, the state transition model ODM receives an image as an input, and detects an object included in the image. The state transition model ODM predicts a trajectory of the detected object.

### Input/Output Unit 40

The input/output unit 40 is an interface with an input device that receives an input of data and an output device that outputs data. Examples of the input device include, but are not limited to, a microphone, a camera, a line-of-sight input device, a keyboard, and a touch pad. Examples of the output device include, but are not limited to, a speaker and a liquid crystal display.

### Communication Unit 50

The communication unit 50 is an interface for transmitting and receiving data via a network. Examples of the communication unit 50 include, but are not limited to, communication chips in various communication standards such as Ethernet (registered trademark), Wi-Fi (registered trademark), and wireless communication standards of mobile data communication networks, and connectors compliant with USB.

The specific configuration of the network is not particularly limited, but as an example, a wireless local area network (LAN), a wired LAN, a wide area network (WAN), a public line network, a mobile data communication network, or a combination of these networks can be used.

### Control Unit 20

The control unit 20 controls each component included in the information processing device 2. As illustrated in FIG. 4, the control unit 20 includes an acquisition unit 21, a trajectory prediction unit 11, a coordinate transformation unit 12, a trajectory correlation unit 13, a trajectory integration unit 14, a spatiotemporal synchronization unit 15, a learning unit 23, an identification information imparting unit 24, and an output unit 25. The acquisition unit 21, the trajectory prediction unit 11, the coordinate transformation unit 12, the trajectory correlation unit 13, the trajectory integration unit 14, the spatiotemporal synchronization unit 15, the learning unit 23, and the identification information imparting unit 24 implement an acquisition means, a trajectory prediction means, a coordinate transformation means, a trajectory correlation means, a trajectory integration means, a spatiotemporal synchronization means, a learning means, and an identification information imparting means, in the present example embodiment.

### Acquisition Unit 21

The acquisition unit 21 acquires data supplied from the input/output unit 40 or the communication unit 50. The acquisition unit 21 stores the acquired data in the storage unit 30.

As an example, the acquisition unit 21 acquires a plurality of target images TP. For example, in FIG. 3 described above, a plurality of images captured by the camera CA1 for a predetermined period is acquired as a plurality of target images TP. Hereinafter, a plurality of images captured by a certain camera CA for a predetermined period is also referred to as a moving image. The acquisition unit 21 similarly acquires the moving images captured by the cameras CA2 to CA4 as the plurality of target images TP for the cameras CA2 to CA4.

### Trajectory Prediction Unit 11

The trajectory prediction unit 11 predicts a trajectory lc of the object included in the image. The trajectory prediction unit 11 stores the trajectory information LCI indicating the predicted one or a plurality of trajectories lc in the storage unit 30.

As an example, the trajectory prediction unit 11 predicts the trajectory lc of the object included in at least one of the plurality of target images TP with reference to the plurality of target images TP. For example, in FIG. 3 described above, the trajectory prediction unit 11 predicts the trajectory lc of the object (person OB1, person OB2, car OB3, and car OB4) included in at least one of the plurality of target images TP with reference to the plurality of target images TP (moving images) captured by the cameras CA1 to CA4 for a predetermined period.

For example, when the person OB2 and the car OB3 are included in a moving image 1 captured by the camera CA1 from time t−n (n is 2 or more) to time t−1, the trajectory prediction unit 11 predicts a trajectory lc_OB2 of the person OB2 and a trajectory lc_OB3 of the car OB3 after time t with reference to the moving image 1.

Similarly, when the person OB1 and the car OB3 are included in a moving image 2 captured by the camera CA2 from time t−n to time t−1, the trajectory prediction unit 11 predicts a trajectory lc_OB1 of the person OB1 and the trajectory lc_OB3 of the car OB3 after time t with reference to the moving image 2.

That is, the trajectory prediction unit 11 predicts the trajectory lc of the object included in the moving image captured by the camera CA for each camera CA.

The trajectory prediction unit 11 may predict the trajectory lc of the object by inputting the target image TP to the state transition model ODM that predicts the state of the object included in an image using the image as an input.

As illustrated in FIG. 4, the trajectory prediction unit 11 includes an object detection unit 111, a trajectory candidate prediction unit 112, a correlation unit 113, and a trajectory determination unit 114.

The object detection unit 111 detects an object included in the image. As an example, the object detection unit 111 detects an object included in the target image TP by inputting the target image TP to the state transition model ODM. As another example, the object detection unit 111 detects an object included in the target image TP using an object detection model (for example, YOLOX) or using generative artificial intelligence (for example, ChatGPT4, Gemini).

The object detection unit 111 supplies information indicating the detected object to the trajectory candidate prediction unit 112.

As an example, the object detection unit 111 supplies an image in which an object included in the target image TP is surrounded by a rectangle to the trajectory candidate prediction unit 112 as information indicating the detected object.

The trajectory candidate prediction unit 112 predicts one or a plurality of trajectory candidates of the object included in the image. The trajectory candidate prediction unit 112 supplies the predicted one or a plurality of trajectory candidates to the correlation unit 113. As an example, the trajectory candidate prediction unit 112 inputs, to the state transition model ODM, a plurality of target images TP (moving images) captured from time t−n to time t−1 and information indicating the object detected by the object detection unit 111 for each of the plurality of target images TP, thereby predicting one or a plurality of trajectory candidates of the object detected by the object detection unit 111 after time t.

The correlation unit 113 calculates the degree of correlation between the detected position of the object and the position of the object in one or a plurality of trajectory candidates. The correlation unit 113 supplies the calculated degree of correlation to the trajectory determination unit 114. As an example, the correlation unit 113 calculates, as a degree of correlation, a difference between a rectangle surrounding the object OB detected by the object detection unit 111 and included in the target image TP captured at time t and the position of the object OB at time t based on one or a plurality of trajectory candidates of the object OB predicted by the trajectory candidate prediction unit 112 from the moving image captured from time t−n to time t−1.

The trajectory determination unit 114 determines one or a plurality of trajectories lc of the object included in the image.

The trajectory determination unit 114 stores trajectory information LCI indicating the determined one or a plurality of trajectories lc in the storage unit 30. For example, the trajectory determination unit 114 determines one or a plurality of trajectories in which the degree of correlation calculated by the correlation unit 113 is equal to or greater than a threshold as one or a plurality of trajectories lc of the object included in the image.

The trajectory determination unit 114 determines the trajectory of the object with reference to the identification information ID assigned by the identification information imparting unit 24 described later. An example of processing in which the trajectory determination unit 114 refers to the identification information ID will be described later.

### Coordinate Transformation Unit 12

The coordinate transformation unit 12 transforms the trajectory lc into reference coordinates. As an example, the coordinate transformation unit 12 transforms each of the plurality of trajectories lc predicted by the trajectory prediction unit 11 into reference coordinates using a parameter PA calculated by the spatiotemporal synchronization unit 15 described later. The coordinate transformation unit 12 stores the post-transformation trajectory information C_LCI indicating the transformed trajectory c_cl in the storage unit 30.

Examples of the method by which the coordinate transformation unit 12 transforms the trajectory cl into the reference coordinates include, but are not limited to, a method of transforming the trajectory cl into the reference coordinates by affine transformation or homography transformation using the parameter PA.

The reference coordinates are not particularly limited, but as an example, in a case where the plurality of cameras CA include the camera CA that captures the object OB from above, the coordinate transformation unit 12 transforms each of the plurality of trajectories lc into the reference coordinates with the target image TP captured by the camera CA that captures the object OB from above as a reference.

In other words, the coordinate transformation unit 12 sets the coordinate system in the target image TP captured by the camera CA captured from above as the reference coordinate system, and transforms the trajectory lc predicted with reference to the target image TP captured by another camera CA into the coordinates of the reference coordinate system. With this configuration, the information processing device 2 can transform the trajectory lc predicted from the target image TP captured by another camera CA into the reference coordinate with the target image TP obtained by capturing the entire motion of the object as a reference.

At least a part of the imaging range of each of the plurality of cameras CA may overlap at least a part of the imaging range of another camera.

### Trajectory Correlation Unit 13

The trajectory correlation unit 13 calculates the degree of correlation between the trajectories lc. As an example, the trajectory correlation unit 13 calculates a degree of correlation with another transformed trajectory c_cl for each of the plurality of transformed trajectories c_lc transformed into the reference coordinates by the coordinate transformation unit 12. The trajectory correlation unit 13 supplies the calculated degree of correlation to the trajectory integration unit 14.

For example, the trajectory correlation unit 13 calculates a degree indicating how similar the trajectories are as the degree of correlation. As an example, the trajectory correlation unit 13 calculates the distance between the trajectories as the degree of correlation. In this case, the trajectory correlation unit 13 calculates the degree of correlation such that the shorter the distance between the trajectories, the higher the degree of correlation.

Further, the trajectory correlation unit 13 may calculate the degree of similarity of state variables such as the speed of the object as the degree of correlation between the trajectories lc. In this case, the trajectory correlation unit 13 calculates the degree of correlation such that the higher the degree of similarity of the state variables, the higher the degree of correlation between the trajectories lc.

### Trajectory Integration Unit 14

The trajectory integration unit 14 integrates the plurality of trajectories lc. As an example, the trajectory integration unit 14 integrates the trajectories lc in which the degree of correlation calculated by the trajectory correlation unit 13 is higher than a predetermined value. The trajectory integration unit 14 stores the integrated trajectory information I_LCI indicating the integrated trajectory i_lc in the storage unit 30.

As an example of a method in which the trajectory integration unit 14 integrates the trajectories lc, there is a method of using optimization by the Greedy method. Another example of the method of integrating the trajectories by the trajectory integration unit 14 is a method using discrete optimization.

### Spatiotemporal Synchronization Unit 15

The spatiotemporal synchronization unit 15 synchronizes the plurality of trajectories lc temporally and spatially. As an example, the spatiotemporal synchronization unit 15 refers to the integrated trajectory i_lc integrated by the trajectory integration unit 14, and calculates the parameter PA for spatially and temporally synchronizing the images captured by the plurality of cameras CA. The spatiotemporal synchronization unit 15 stores the calculated parameter PA in the storage unit 30.

Examples of the parameter PA calculated by the spatiotemporal synchronization unit 15 include, but are not limited to, rotation, translation, focal length, camera center coordinates, and camera lens distortion as described above.

As an example of the processing executed by the spatiotemporal synchronization unit 15, it is assumed that the integrated trajectory i_lc integrated by the trajectory integration unit 14 is a trajectory lc_1 predicted from the image captured by the camera CA1 and a trajectory lc_2 predicted from the image captured by the camera CA2. In this case, the spatiotemporal synchronization unit 15 projects the trajectory lc_1 and the trajectory lc_2 onto a certain plane. Next, the spatiotemporal synchronization unit 15 calculates a spatial difference and a temporal difference between the trajectory lc_1 and the trajectory lc_2 based on the position of each of the camera CA1 and the camera CA2 and the direction in which each of the cameras CA1 and CA2 faces. Then, the spatiotemporal synchronization unit 15 calculates the parameter PA in the three-dimensional reference coordinate from the calculated difference.

As described above, in a case where at least a part of the imaging range of each of the plurality of cameras CA overlaps with at least a part of the imaging range of another camera, the spatiotemporal synchronization unit 15 can easily calculate the parameter PA to be spatially and temporally synchronized by referring to the position of the object in the overlapping region.

### Learning Unit 23

The learning unit 23 learns a machine learning model. As an example, the learning unit 23 learns the state transition model ODM by using the integrated trajectory i_lc integrated by the trajectory integration unit 14.

As an example of the processing executed by the learning unit 23, the learning unit 23 models a linear or non-linear state update equation conditional on the position and speed of the object based on the integrated trajectory i_lc, and calculates the parameter of the update equation from the accumulated data by regression. For example, the learning unit 23 learns the conditional state transition model ODM such that a certain object moves in a certain direction at a certain place.

With this configuration, the learning unit 23 can learn the state transition model ODM that predicts the trajectory of the object included in an image using the image as an input.

### Identification Information Imparting Unit 24

The identification information imparting unit 24 associates an object included in the image with an identification information ID for identifying the object from another object. As an example, the identification information imparting unit 24 associates an identification information ID for identifying an object included in at least one of the plurality of target images TP with another object with the object.

For example, the identification information imparting unit 24 identifies the object included in the target image TP using an individual identification method based on biometric authentication such as face authentication or gait authentication. Further, the identification information imparting unit 24 identifies the object included in the target image TP using a mechanical authentication method such as radio frequency identification (RFID). The identification information imparting unit 24 associates an identification information ID indicating the identified object with the identified object.

The identification information ID associated with the object by the identification information imparting unit 24 may be associated with information regarding the trajectory lc. For example, the identification information ID of a certain object may be associated with the trajectory lc along which the certain object has moved in the past.

In this case, the trajectory determination unit 114 refers to the identification information ID and determines the trajectory lc of the object.

For example, the trajectory determination unit 114 determines one or a plurality of trajectories lc as the trajectory of the object when the degree of similarity between one or a plurality of trajectories lc in which the degree of correlation calculated by the correlation unit 113 is equal to or greater than the threshold and the trajectory lc associated with the identification information ID is equal to or greater than the threshold.

With this configuration, the trajectory determination unit 114 can determine the trajectory lc of the object with higher accuracy.

### Output Unit 25

The output unit 25 outputs data to the input/output unit 40 or the communication unit 50. As an example, the output unit 25 outputs the integrated trajectory i_lc to the input/output unit 40 or the communication unit 50.

### Flow of Information Processing Method S2

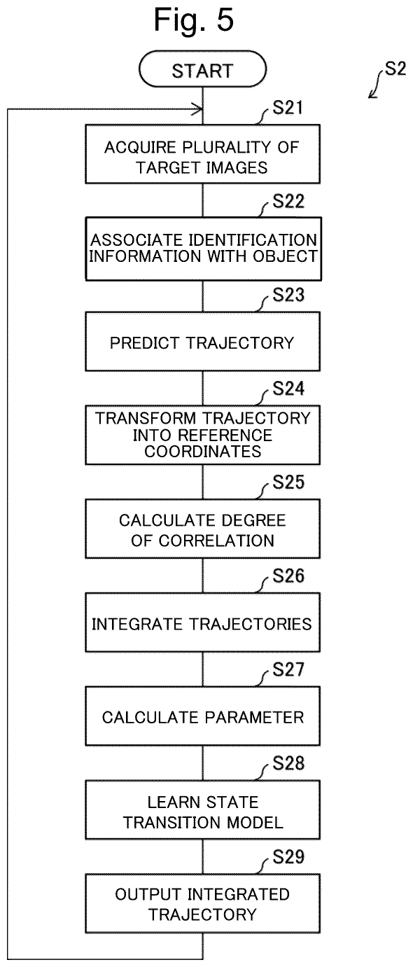

A flow of an information processing method S2 executed by the information processing device 2 will be described with reference to FIG. 5. FIG. 5 is a flowchart illustrating the flow of the information processing method S2.

### Step S21

In step S21, the acquisition unit 21 acquires a plurality of target images TP. The acquisition unit 21 stores the plurality of target images TP in the storage unit 30.

### Step S22

In step S22, the identification information imparting unit 24 associates the identification information ID of the object included in the target image TP with the object for each of the plurality of target images TP.

### Step S23

In step S23, the trajectory prediction unit 11 predicts the trajectory lc of the object included in at least one of the plurality of target images TP with reference to the plurality of target images TP. The trajectory prediction unit 11 stores the trajectory information LCI indicating the predicted trajectory lc in the storage unit 30.

### Step S24

In step S24, the coordinate transformation unit 12 transforms each of the plurality of trajectories lc predicted by the trajectory prediction unit 11 into reference coordinates with reference to the parameter PA. The coordinate transformation unit 12 stores the post-transformation trajectory information C_LCI indicating the transformed trajectory c_cl in the storage unit 30.

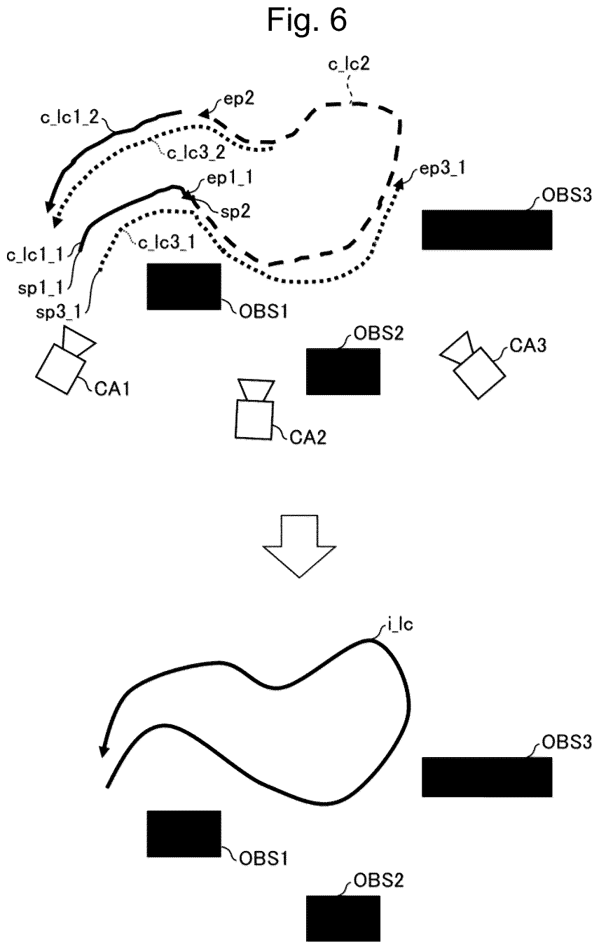

An example of the transformed trajectory c_cl will be described with reference to FIG. 6. FIG. 6 is a diagram illustrating an example of processing in which the information processing device 2 generates the integrated trajectory i_lc.

As illustrated in FIG. 6, in the target image TP captured by the cameras CA1 to CA3, it is assumed that the object is in an occlusion state hidden behind an obstacle OBS1, an obstacle OBS2, or an obstacle OBS3.

In this case, as illustrated in the upper part of FIG. 6, the trajectory prediction unit 11 predicts the trajectory lc1_1 and the trajectory lc1_2 with reference to a plurality of target images TP1 captured by the camera CA1. Similarly, the trajectory prediction unit 11 predicts the trajectory lc2 with reference to the plurality of target images TP2 captured by the camera CA2. The trajectory prediction unit 11 predicts a trajectory lc3_1 and a trajectory lc3_2 with reference to the plurality of target images TP3 captured by the camera CA3.

In this case, as illustrated in the upper part of FIG. 6, the coordinate transformation unit 12 generates a transformed trajectory c_lc1_1, a transformed trajectory c_cl1_2, a transformed trajectory c_lc2, a transformed trajectory c_lc3_1, and a transformed trajectory c_lc3_2 in the reference coordinates from each of the plurality of trajectories lc into reference coordinates.

### Step S25

In step S25, the trajectory correlation unit 13 calculates the degree of correlation with other trajectories for each of the plurality of transformed trajectories c_lc transformed into the reference coordinates by the coordinate transformation unit 12. The trajectory correlation unit 13 supplies the calculated degree of correlation to the trajectory integration unit 14.

As an example, the trajectory correlation unit 13 first executes first selection processing of selecting one transformed trajectory c_lc among the plurality of transformed trajectories c_lc. Next, the trajectory correlation unit 13 executes second selection processing of selecting one or a plurality of transformed trajectories c_lc existing within a predetermined range from the transformed trajectory c_lc selected in the first selection processing. The predetermined range is not particularly limited, and examples thereof include a range determined by the trajectory correlation unit 13 when trajectories are similar to each other.

Subsequently, the trajectory correlation unit 13 executes degree calculation processing of calculating a degree of correlation between the transformed trajectory c_lc selected in the first selection processing and each of the one or a plurality of transformed trajectories c_lc selected in the second selection processing. The trajectory correlation unit 13 repeats the first selection processing, the second selection processing, and the degree calculation processing until all the transformed trajectories c_lc are selected in the first selection processing.

For example, in the upper part of FIG. 6, the trajectory correlation unit 13 selects the transformed trajectory c_lc1_1 in the first selection process.

Next, in the second selection process, the trajectory correlation unit 13 selects the transformed trajectory c_lc3_1 and the transformed trajectory c_lc2 as one or a plurality of transformed trajectories c_lc existing within a predetermined range from the transformed trajectory c_lc1_1 selected in the first selection process.

Subsequently, in the degree calculation processing, the trajectory correlation unit 13 calculates the degree of correlation between a transformed trajectory c_lc1_1 selected in the first selection processing and each of a transformed trajectory c_lc3_1 and a transformed trajectory c_lc2 selected in the second selection processing.

As an example, it is assumed that the trajectory correlation unit 13 calculates the degree of correlation between the transformed trajectory c_lc1_1 and the transformed trajectory c_lc3_1. In this case, the trajectory correlation unit 13 determines whether the transformed trajectory c_lc3_1 exists within a predetermined range from each of the start point sp1_1 that is a point at which the transformed trajectory c_lc1_1 starts and the end point ep1_1 that is a point at which the transformed trajectory c_lc1_1 ends.

As illustrated in the upper part of FIG. 6, the transformed trajectory c_lc3_1 exists within a predetermined range from each of the start point sp1_1 and the end point ep1_1. Therefore, the trajectory correlation unit 13 calculates the degree of correlation between the transformed trajectory c_lc1_1 and the transformed trajectory c_lc3_1 in the section from a start point sp1_1 to an end point ep1_1. As illustrated in the upper part of FIG. 6, the degree of correlation between the transformed trajectory c_lc1_1 and the transformed trajectory c_lc3_1 increases from the start point sp1_1 to the end point ep1_1.

As another example, it is assumed that the trajectory correlation unit 13 calculates the degree of correlation between the transformed trajectory c_lc1_1 and the transformed trajectory c_lc2. Similarly in this case, the trajectory correlation unit 13 determines whether the transformed trajectory c_lc2 exists within a predetermined range from each of the start point sp1_1 and the end point ep1_1 of the transformed trajectory c_lc1_1.

Here, the transformed trajectory c_lc2 (start point sp2) exists within the predetermined range of the end point ep1_1, but the transformed trajectory c_lc2 does not exist within the predetermined range of the start point sp1_1. Therefore, the trajectory correlation unit 13 determines whether the transformed trajectory c_lc1_1 exists within a predetermined range from each of the start point sp2 and the end point ep2 of the transformed trajectory c_lc2. Also in this case, the transformed trajectory c_lc1_1 (end point ep1_1) exists within the predetermined range of the start point sp2, but the transformed trajectory c_lc1_1 does not exist within the predetermined range of the end point ep2. That is, in the transformed trajectory c_lc1_1 and the transformed trajectory c_lc2, the end point ep1_1 of the transformed trajectory c_lc1_1 and the start point sp2 of the transformed trajectory c_lc2 exist within a predetermined range, but there is no section having similar trajectories. Therefore, the degree of correlation between the transformed trajectory c_lc1_1 and the transformed trajectory c_lc2 becomes low.

As still another example, it is assumed that the trajectory correlation unit 13 calculates the degree of correlation between the transformed trajectory c_lc2 and the transformed trajectory c_lc3_1. Similarly in this case, the trajectory correlation unit 13 determines whether the transformed trajectory c_lc2 exists within a predetermined range from each of the start point sp2 and the end point ep2 of the transformed trajectory c_lc2.

Here, the transformed trajectory c_lc3_1 exists within the predetermined range of the start point sp2, but the transformed trajectory c_lc3_1 does not exist within the predetermined range of the end point ep2. Therefore, similarly to the example described above, the trajectory correlation unit 13 determines whether the transformed trajectory c_lc2 exists within a predetermined range from each of a start point sp3_1 and an end point ep3_1 of the transformed trajectory c_lc3_1. In this case, the transformed trajectory c_lc2 does not exist within the predetermined range of the start point sp3_1, but the transformed trajectory c_lc2 exists within the predetermined range of the end point ep3_1. That is, the trajectory is similar in a section from the start point sp2 of the transformed trajectory c_lc2 to the end point ep3_1 of the transformed trajectory c_lc3_1. Therefore, in the section from a start point sp2 of the transformed trajectory c_lc2 to an end point ep3_1 of the transformed trajectory c_lc3_1, the trajectory correlation unit 13 calculates the degree of correlation between the transformed trajectory c_lc2 and the transformed trajectory c_lc3_1. As illustrated in the upper part of FIG. 6, the degree of correlation between the transformed trajectory c_lc2 and the transformed trajectory c_lc3_1 increases in the section from the start point sp2 of the transformed trajectory c_lc2 to the end point ep3_1 of the transformed trajectory c_lc3_1.

By executing the above processing, the degree of correlation between the transformed trajectory c_lc1_1 and the transformed trajectory c_lc3_1 increases in the upper part of FIG. 6. Similarly, the degree of correlation between the transformed trajectory c_lc2 and the trajectory c_lc3_1 increases. The degree of correlation between the transformed trajectory c_lc2 and the transformed trajectory c_lc3_2 increases. The degree of correlation between the transformed trajectory c_lc1_2 and the transformed trajectory c_lc3_2 increases.

### Step S26

In step S26, the trajectory integration unit 14 integrates the trajectories lc having a degree of correlation calculated by the trajectory correlation unit 13 higher than a predetermined value. The trajectory integration unit 14 stores the integrated trajectory information I_LCI indicating the integrated trajectory i_lc in the storage unit 30.

For example, as described above, when (1) the transformed trajectory c_lc1_1 and the transformed trajectory c_lc3_1, (2) the degree of correlation between the transformed trajectory c_lc2 and the trajectory c_lc3_1, (3) the degree of correlation between the transformed trajectory c_lc2 and the transformed trajectory c_lc3_2, and (4) the degree of correlation between the transformed trajectory c_lc1_2 and the transformed trajectory c_lc3_2 are higher than a predetermined value, the trajectory integration unit 14 integrates the trajectories having high degrees of correlation to generate an integrated trajectory i_lc, as illustrated in the lower part of FIG. 6.

### Step S27

In step S27, the spatiotemporal synchronization unit 15 refers to the integrated trajectory i_lc integrated by the trajectory integration unit 14, and calculates the parameter PA for spatially and temporally synchronizing the images captured by the plurality of cameras CA. The spatiotemporal synchronization unit 15 stores the calculated parameter PA in the storage unit 30.

### Step S28

In step S28, the learning unit 23 learns the state transition model ODM by using the integrated trajectory i_lc integrated by the trajectory integration unit 14.

### Step S29

In step S29, the output unit 25 outputs the integrated trajectory i_lc to the input/output unit 40 or the communication unit 50.

After executing step S29, the information processing device 2 returns to step S21 again and repeats the processing of steps S21 to S29.

Here, in step S23, the trajectory prediction unit 11 may be configured to sequentially predict the trajectory of the object with reference to a plurality of target images sequentially captured by the plurality of cameras CA.

That is, in step S21, the acquisition unit 21 acquires the plurality of target images TP sequentially captured by each of the plurality of cameras CA. For example, in step S21, the acquisition unit 21 acquires a plurality of target images TP1 obtained by photographing a period from time t−1 to time t. In step S23, the trajectory prediction unit 11 predicts the trajectory lc1 of the object with reference to the plurality of target images TP1.

When step S29 is executed, in step S21, the acquisition unit 21 again acquires the plurality of target images TP2 obtained by photographing the period from time t to time t+1. In step S23, the trajectory prediction unit 11 predicts the trajectory lc2 of the object with reference to the plurality of target images TP2.

With this configuration, the information processing device 2 can predict the trajectory of the object included in the sequentially captured target image TP.

The information processing device 2 may repeatedly execute steps S21 to S29 using a plurality of target images captured in a predetermined period.

That is, in step S21, the acquisition unit 21 acquires the plurality of target images TP captured during the predetermined period stored in the storage unit 30. Then, using the plurality of target images TP, the information processing device 2 repeatedly executes the process of predicting a trajectory by the trajectory prediction unit 11, the process of transforming to the reference coordinates by the coordinate transformation unit 12 with reference to the parameter PA, the process of calculating the degree of correlation by the trajectory correlation unit 13, the process of integrating the trajectories by the trajectory integration unit 14, and the process of calculating the parameter by the spatiotemporal synchronization unit 15.

With this configuration, since the information processing device 2 repeatedly executes the processing, the coordinate transformation unit 12 transforms the trajectory lc into the reference coordinates using the updated parameters. Therefore, the information processing device 2 can predict the integrated trajectory i_lc with higher accuracy.

### Effects of Information Processing Device 2

As described above, in the information processing device 2, even if the object is brought into the occlusion state by the obstacles OBS1 to OBS3 as illustrated in FIG. 6, the integrated trajectory i_lc of the object can be generated. Therefore, the information processing device 2 can predict the trajectory of the object with high accuracy.

### Example of Implementation by Software

Some or all of the functions of the information processing devices 1 and 2 (hereinafter, also referred to as “each of the above devices”) may be implemented by hardware such as an integrated circuit (an IC chip) or may be implemented by software.

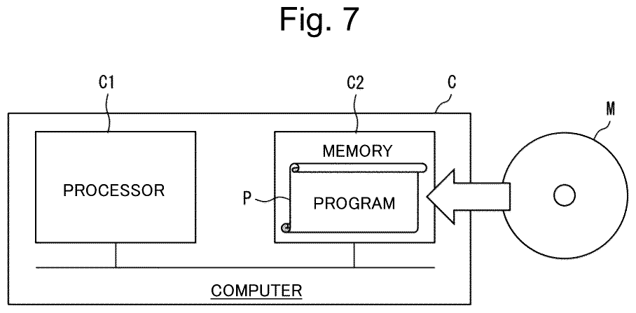

In the latter case, each of the above devices is implemented by, for example, a computer that executes a command of a program which is software for implementing each function. An example of such a computer (hereinafter, referred to as a computer C) is illustrated in FIG. 7. FIG. 7 is a block diagram illustrating a hardware configuration of the computer C functioning as each of the above devices.

The computer C includes at least one processor Cl and at least one memory C2. A program P for causing the computer C to operate as each of the above devices is recorded in the memory C2. In the computer C, the processor C1 reads the program P from the memory C2 and executes the program P to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

In the multiple-object tracking device, since the plurality of cameras are not synchronized, there is a possibility that a detection result in an image of a certain camera and a detection result in an image of another camera are different for a position of a certain object. Therefore, in the multiple-object tracking device, there is a problem that accuracy of a predicted tracking result becomes low.

An exemplary object of the present disclosure is to provide a technique and the like for accurately predicting a trajectory of an object.

### SUPPLEMENTARY NOTES

The present disclosure includes the technologies described in the following supplementary notes. However, the present disclosure is not limited to the techniques described in the following supplementary notes, and various modifications can be made within the scope described in the claims.

### Supplementary Note A1

An information processing device including:
a trajectory prediction means for predicting, for each of a plurality of cameras, a trajectory of an object included in at least one of a plurality of target images with reference to the plurality of target images captured by the plurality of cameras;
a coordinate transformation means for transforming each of a plurality of trajectories predicted by the trajectory prediction means into reference coordinates;
a trajectory correlation means for calculating a degree of correlation with another trajectory for each of the plurality of trajectories transformed into the reference coordinates;
a trajectory integration means for integrating trajectories having the degree of correlation higher than a predetermined value; and
a spatiotemporal synchronization means for calculating parameters for spatially and temporally synchronizing images captured by the plurality of cameras with reference to a trajectory integrated by the trajectory integration means,
in which the coordinate transformation means transforms each of the plurality of trajectories into the reference coordinate with reference to the parameter.

### Supplementary Note A2

The information processing device according to Supplementary Note A1, in which
the trajectory prediction means predicts a trajectory of an object by inputting the target image to a state transition model that predicts a state of the object included in an image using the image as an input, and
the information processing device further comprises a learning means for learning the state transition model using a trajectory integrated by the trajectory integration means.

### Supplementary Note A3

The information processing device according to Supplementary Note A1 or A2, further including an identification information imparting means for associating, with the object, identification information for identifying an object included in at least one of the plurality of target images with another object,
in which the trajectory prediction means refers to the identification information and predicts a trajectory of the object.

### Supplementary Note A4

The information processing device according to any one of Supplementary Notes A1 to A3, in which
the plurality of cameras includes a camera that captures the object from above, and
the coordinate transformation means transforms each of the plurality of trajectories into reference coordinates with a target image captured by the camera that captures an image from above as a reference.

### Supplementary Note A5

The information processing device according to any one of Supplementary Notes A1 to A4, in which at least a part of an imaging range of each of the plurality of cameras overlaps at least a part of an imaging range of another camera.

### Supplementary Note A6

The information processing device according to any one of Supplementary Notes A1 to A5, in which the trajectory prediction means sequentially predicts a trajectory of the object with reference to a plurality of target images sequentially captured by each of the plurality of cameras.

### Supplementary Note A7

The information processing device according to any one of Supplementary Notes A1 to A5, in which
using a plurality of target images captured in a predetermined period by the plurality of cameras, the information processing device repeatedly executes:
a process of predicting a trajectory by the trajectory prediction means;
a process of transforming to the reference coordinate by the coordinate transformation means with reference to the parameter;
a process of calculating the degree of correlation by the trajectory correlation means;
a process of integrating trajectories by the trajectory integration means; and
a process of calculating the parameter by the spatiotemporal synchronization means.

### Supplementary Note B1

An information processing method for causing at least one processor to execute:
a process of predicting, for each of a plurality of cameras, a trajectory of an object included in at least one of a plurality of target images with reference to the plurality of target images captured by the plurality of cameras;
a process of transforming each of a plurality of trajectories predicted by the trajectory prediction processing into reference coordinates;
a process of calculating a degree of correlation with another trajectory for each of the plurality of trajectories transformed into the reference coordinates;
a process of integrating trajectories having the degree of correlation higher than a predetermined value; and
a process of calculating parameters for spatially and temporally synchronizing images captured by the plurality of cameras with reference to a trajectory integrated by the trajectory integration processing,
in which in the coordinate transformation processing, the at least one processor transforms each of the plurality of trajectories into the reference coordinate with reference to the parameter.

### Supplementary Note C1

An information processing program for causing a computer to function as an information processing device including:
a trajectory prediction means for predicting, for each of a plurality of cameras, a trajectory of an object included in at least one of a plurality of target images with reference to the plurality of target images captured by the plurality of cameras;
a coordinate transformation means for transforming each of a plurality of trajectories predicted by the trajectory prediction means into reference coordinates;
a trajectory correlation means for calculating a degree of correlation with another trajectory for each of the plurality of trajectories transformed into the reference coordinates;
a trajectory integration means for integrating trajectories having the degree of correlation higher than a predetermined value; and
a spatiotemporal synchronization means for calculating parameters for spatially and temporally synchronizing images captured by the plurality of cameras with reference to a trajectory integrated by the trajectory integration means,
in which the coordinate transformation means transforms each of the plurality of trajectories into the reference coordinate with reference to the parameter.

While the disclosure has been particularly shown and described with reference to example embodiments thereof, the disclosure is not limited to these embodiments. It will be understood by those of ordinary skill in the art that various changes in form and details may be made therein without departing from the spirit and scope of the present disclosure as defined by the claims.

1. An information processing device comprising:
a memory configured to store instructions; and
one or more processors configured to execute the instructions to:
predict, for each of a plurality of cameras, a trajectory of an object included in at least one of a plurality of target images with reference to the plurality of target images captured by the plurality of cameras;
transform each of the plurality of predicted trajectories into reference coordinates;
calculate a degree of correlation with another trajectory for each of the plurality of trajectories transformed into the reference coordinates;
integrate trajectories having the degree of correlation higher than a predetermined value;
calculate parameters for spatially and temporally synchronizing images captured by the plurality of cameras with reference to the integrated trajectory; and
transform each of the plurality of trajectories into the reference coordinate with reference to the parameter.

2. The information processing device according to claim 1, wherein
the one or more processors are further configured to execute the instructions to: predict a trajectory of an object by inputting the target image to a state transition model that predicts a state of the object included in an image using the image as an input; and
learn the state transition model using a trajectory integrated.

3. The information processing device according to claim 1, wherein
the one or more processors are further configured to execute the instructions to: associate, with the object, identification information for identifying an object included in at least one of the plurality of target images with another object; and
refer to the identification information to predict a trajectory of the object.

4. The information processing device according to claim 1, wherein
the plurality of cameras includes a camera that captures the object from above, wherein
the one or more processors are further configured to execute the instructions to: transform each of the plurality of trajectories into reference coordinates with a target image captured by the camera that captures an image from above as a reference.

5. The information processing device according to claim 1, wherein
at least a part of an imaging range of each of the plurality of cameras overlaps at least a part of an imaging range of another camera.

6. The information processing device according to claim 1, wherein
the one or more processors are further configured to execute the instructions to: sequentially predict a trajectory of the object with reference to a plurality of target images sequentially captured by each of the plurality of cameras.

7. The information processing device according to claim 1, wherein
using a plurality of target images captured in a predetermined period by the plurality of cameras, the one or more processors are further configured to execute the instructions to:
predict a trajectory;
transform to the reference coordinate with reference to the parameter;
calculate the degree of correlation;
integrate trajectories; and
calculate the parameter.

8. An information processing method, performed by at least one processor, comprising:
predicting, for each of a plurality of cameras, a trajectory of an object included in at least one of a plurality of target images with reference to the plurality of target images captured by the plurality of cameras;
transforming each of a plurality of the predicted trajectories into reference coordinates;
calculating a degree of correlation with another trajectory for each of the plurality of trajectories transformed into the reference coordinates;
integrating trajectories having the degree of correlation higher than a predetermined value;
calculating parameters for spatially and temporally synchronizing images captured by the plurality of cameras with reference to the integrated trajectory; and,
transforming each of the plurality of trajectories into the reference coordinate with reference to the parameter.

9. A non-transitory computer-readable recording medium recording a program for causing a computer to execute the steps of:
predicting, for each of a plurality of cameras, a trajectory of an object included in at least one of a plurality of target images with reference to the plurality of target images captured by the plurality of cameras;
transforming each of a plurality of the predicted trajectories into reference coordinates;
calculating a degree of correlation with another trajectory for each of the plurality of trajectories transformed into the reference coordinates;
integrating trajectories having the degree of correlation higher than a predetermined value;
calculating parameters for spatially and temporally synchronizing images captured by the plurality of cameras with reference to the integrated trajectory; and
transforming each of the plurality of trajectories into the reference coordinate with reference to the parameter.
